(19) United States
(12) Patent Application Publication
(10) Pub. No.: US 2003/0000754 A1
(43) Pub. Date: Jan. 2, 2003

(54) Powered lightweight personal transportation vehicle

(76) Inventor: Stephen William Daudt, (US)

Correspondence Address: June B. Schuette, 2902 Waterstone Ct., Ft. Collins, CO, 80525, US

(21) Appl. No.: 09/876,284

(22) Filed: Jun. 7, 2001

(51) Int. Cl. B62K 11/00

(52) U.S. Cl. 180/220; 280/287

(57) ABSTRACT

A personal transportation vehicle has a frame 101 with a seat 104, handlebars 108 and first and second axles 102,103. First and second wheels 105,106 and tires are positioned on respective ones of the first and second axles 102,103. A motor 110 drives at least one of the wheels 105 or 106 to propel the vehicle in a forward direction. A footrest 112 receives a portion of a rider's 201 weight and a force transfer element 302 transfers the force from the rider's weight to the first axle 102 of the vehicle. Among other advantages, a “foot forward” body position permits a small wheelbase for the vehicle while providing for a safe, stable and comfortable riding position.

### BACKGROUND

There are many forms of personal transportation. Two major categories of personal transportation include transportation modes powered by a motor and transportation modes powered through efforts of man or beast. Individuals may use more that one form of personal transportation depending upon the distance to be traveled and the speed with which the desired distance must be covered and the transportation modes and infrastructure most prevalent and available in the country of travel.

Generally, non-motor powered personal transportation, bicycles for example, is appropriate for short distances and slow to moderate speeds. Advantageously, bicycles are relatively small and lightweight and require minimal effort, cost, and space for storage when not in use. Powered transportation, a car for example, is appropriate for long distances and moderate to high speeds. Relative to bicycles however, cars are large, heavy and require relatively greater effort, cost, and space when not in use. There exists a middle ground where the distance and the speed of travel are moderate. In this middle case, a bicycle may not be desirable because of the physical effort required to propel the vehicle and a car is not desirable because of the inconvenience and cost of finding a space for storage after the rider has reached the destination. This middle ground is addressed to date with devices such as motorcycles and motor scooters.

Motorcycles and motor scooters are smaller than cars and are powered by a motor so they can sustain higher speeds for a longer period of time than a non-powered bicycle. U.S. Pat. No. 3,513,926 issued to R. E. Paget, Jr. and U.S. Pat. No. 4,026,573 issued to Richardson disclose two-wheeled foldable transportation vehicles. Advantageously, the transportation vehicles disclosed are small and powered. Both vehicles, however, appear to be somewhat bulky and, while foldable, are not as lightweight and compact as may be desirable. An advantage of a compact and lightweight transportation vehicle is the possibility of using a transportation method that utilizes a combination of public transportation and personal transportation. If a personal transportation vehicle is lightweight and compact, a rider can take a personal transportation vehicle to a place where public transportation (i.e. bus, subway, train) is readily accessible, carry the personal transportation vehicle on the public transportation, and then ride the personal transportation vehicle to a final destination. Once there, a compact and lightweight personal transportation vehicle may be carried to an ultimate destination (i.e. office or apartment) obviating the need for availability of on street vehicle storage. As one of ordinary skill in the art can appreciate, such a device permits a door-to-door transportation method in a cost-effective and environmentally responsible way.

There remains a need therefore, for a smaller and more lightweight personal transportation vehicle.

### SUMMARY

As a solution to the aforementioned issues with the current state of the art, a personal transportation vehicle comprises a frame having first and second axles mounted thereon. First and second wheels are positioned on respective ones of the first and second axles. A motor drives at least one of the wheels. The frame supports a seat. The vehicle also has a footrest and a force transfer element that receives a force placed on the footrest and transfers the force to the first axle.

A personal transportation vehicle comprises a frame having first and second axles mounted thereon. First and second wheels are positioned on respective ones of the first and second axles. The personal transportation vehicle further comprises a means for supporting a seat on the frame, a means for propelling at least one of the wheels, a means for providing a footrest, and a means for receiving a force placed on the footrest and transferring the force to the first axle.

A personal transportation vehicle comprises a frame having a seat, first and second axles, a pivotable fork stem and handlebars for controlling the pivotable fork stem. First and second wheels are mounted to the frame on respective ones of the first and second axles. A motor propels at least one of the wheels. The vehicle also has a footrest and a force transfer element that receives a force placed on the footrest and transfers the force to the first axle.

Advantageously, a personal transportation vehicle according to the teachings of the present invention provides for a novel body position for a rider permitting the use of an aggressively small frame and lightweight design. Additionally, the novel body position is a safe, comfortable, and stable riding position.

### BRIEF DESCRIPTION OF THE DRAWINGS

FIG. 1 is a plan view of a personal transportation vehicle according to the teachings of the present invention.

FIG. 2 is a representation of a rider on a personal transportation vehicle according to the teachings of the present invention.

FIG. 3 is a cross sectional view perpendicular to the plane of the first wheel and through the footrest, showing a first embodiment of a footrest and force transfer element according to the teachings of the present invention.

FIG. 4 is a cross sectional view cut perpendicular to the plane of the first wheel and through the footrest, showing a second embodiment of a footrest and force transfer element according to the teachings of the present invention.

FIG. 5 is a cross sectional view perpendicular to the plane of the first wheel and through the footrest, showing a third embodiment of a footrest and force transfer element according to the teachings of the present invention.

FIG. 6 is a cross sectional view perpendicular to the plane of the first wheel and through the footrest, showing a fourth embodiment of a footrest and force transfer element according to the teachings of the present invention.

FIG. 7 is a cross sectional view perpendicular to the plane of the first wheel and through the footrest, showing a fifth embodiment of a footrest and force transfer element according to the teachings of the present invention.

FIGS. 8 through 13 is a perspective view of an embodiment of a fold sequence for a personal transportation vehicle according to the teachings of the present invention.

FIG. 14 is a perspective view of an embodiment of a completely folded personal transportation vehicle as stored in a carry case according to the teachings of the present invention.

### DETAILED DESCRIPTION

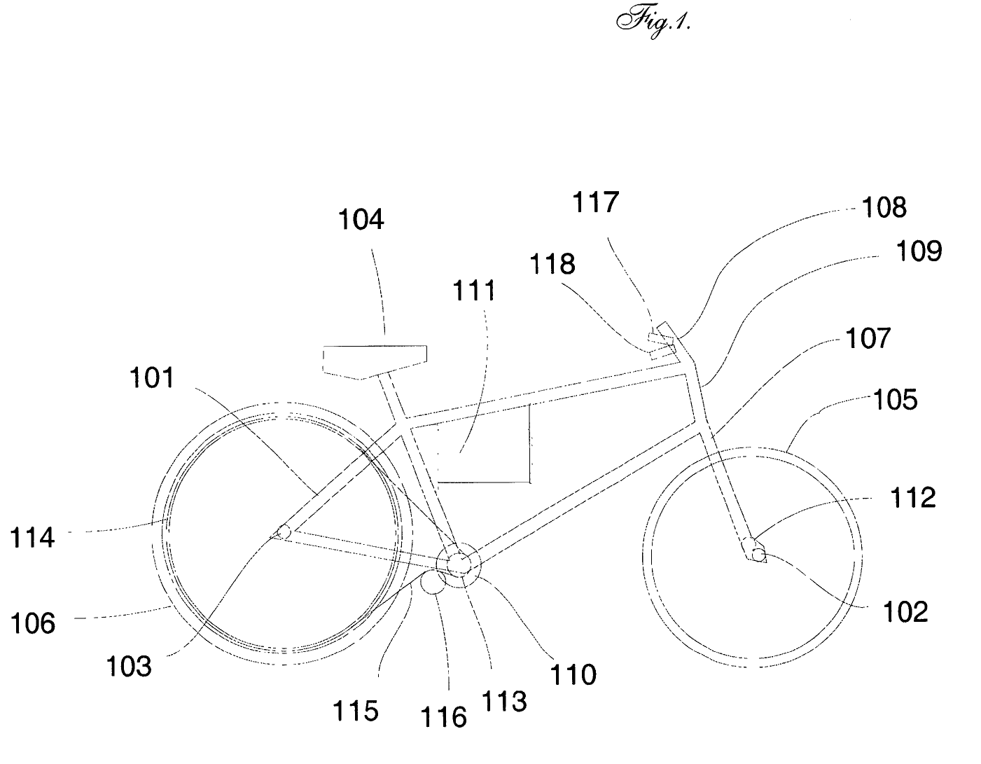

FIG. 1 of the drawings shows a personal transportation vehicle according to the teachings of the present invention in which a frame 101 has first and second axles 102, 103, a seat 104, first and second wheels 105, 106 mounted on respective ones of the first and second axles 102, 103, a pivotable fork stem 107, and handlebars 108 connected to the fork stem 107 via head tube 109. The components 101-109 that are mentioned above and their relative attachment to each other may be that of a conventional bicycle frame without pedals as shown in FIG. 1. A high rpm electric motor 110, such as a permanent magnet, ironless rotor, DC brush motor, drives the second wheel 106 using a timing belt type drive. A small drive sprocket 113 is attached to motor shaft. A large sprocket 114 is attached to the second wheel 106. The large rear sprocket 114 can be attached directly beside a wheel rim similar to the hand wheel on a wheel chair. This permits a large gear reduction of up to 20 to 1 or more. The rear sprocket must not be of larger diameter than the wheel rim to account for flat tires unless the sprocket can support the vehicle during such occurrences. Alternatively the rear sprocket 114 can be integral to the second wheel 106 or attached to spokes or the wheel hub. A cogged belt 115 links the two pulleys. A spring loaded tensioner 116 accounts for wheel dissymmetry and keeps a large number of cogs engaged in the small drive sprocket. This type drive provides high efficiency transfer from motor to wheels and is resistent to dirt and water problems. It can support regenerative braking whereby wheel momentum is driven back into the motor. An energy storage device 111, such as a metal hydride or lithium ion battery, runs the motor 110 for sustained travel. The motor 110 is controlled by a throttle 117, an on/off switch, and a current limiter to give the rider 201 control and provide protection. The vehicle is also provided a means of braking independent of the motor as shown with the handbrake 118. Alternate embodiments may use a combustion motor for power or any other type of power drive for the first or the second wheel 105,106. The high rpm DC electric motor 110 and lithium ion battery combination was chosen for the disclosed embodiment for its small size and weight and general commercial availability.

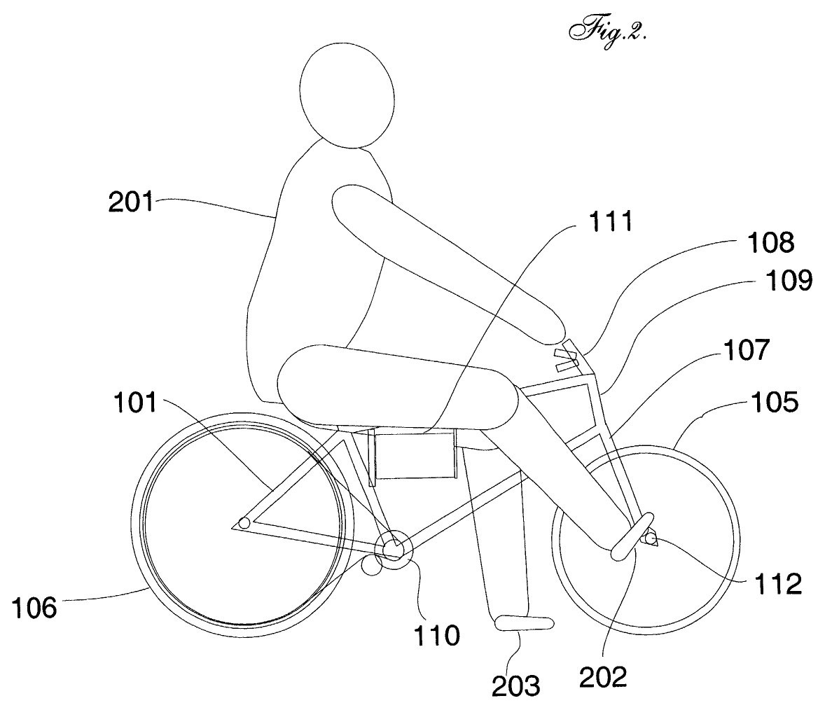

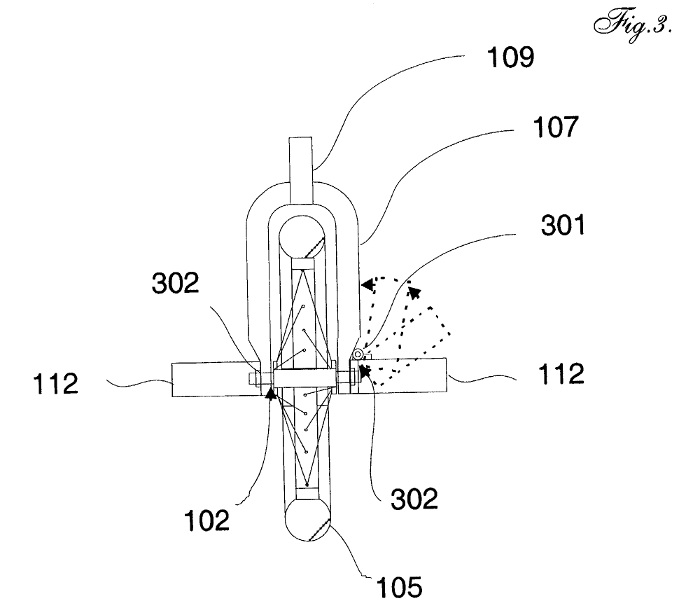

In a first embodiment, the first axle 102 has a footrest 112 connected thereto that is perpendicular to a plane of the first wheel 105 and extends on either side of the first wheel 105. With specific reference to FIG. 3 of the drawings, there is shown a cross sectional view cut in a plane perpendicular to the first wheel 105 through the first axle 102. In the embodiment shown, the footrest 112 is co-linear with the first axle 102 and extends past where the fork stem 107 attaches to the first axle 102. With respect to FIG. 2 of the drawings, a rider 201 of a personal transportation vehicle according to the teachings of the present invention may place each foot 202, 203 on the footrest 112 while the vehicle is in motion. A force transfer element (not shown in FIG. 2, but shown and described in FIG. 3 and later drawings) causes a force that is received by the footrest 112 to be transferred to the first axle 102 and first wheel 105. The distance between the seat 104 and the footrest 112, which is matched to the rider's leg length, therefore, defines an appropriate size of the frame 101 for the rider 201. When the vehicle is stationary, one or both of the rider's feet 202, 203 may be placed on the ground to keep the vehicle upright while the rider remains seated. The rider's feet and legs may also assist in acceleration and deceleration of the vehicle. Accordingly, the appropriate height of the seat 104 for the rider 201 permits comfortable and solid placement of the rider's feet 202, 203 on the road surface. Acceleration and deceleration assistance from the rider 201 permits use of a motor 110 smaller that one required without such assistance and adds an extra margin of safety for the rider 201. The placement of the footrest in a “feet forward” body position advantageously provides a relatively short wheelbase relative to the rider's size for the personal transportation vehicle while maintaining a stable riding position. This further enhances the compact and lightweight nature of the vehicle. Additionally, the feet forward position provides for a feet first impact in the event of a collision thereby enhancing the safety of the vehicle. Furthermore, the upright body position enhances the rider's ability to see obstacles and other vehicles on the road also enhancing the safety of the rider 201.

With specific reference to FIG. 3 of the drawings, there is shown a cross sectional view of an embodiment of the footrest 112 and the force transfer element 302. In the embodiment shown in FIG. 3, the footrest 112 is co-linear with and connected to the first axle 102. The force transfer element 302 in the embodiment of FIG. 3 comprises the mechanical connection between the footrest 112 and the first axle 102 that causes a force placed on the footrest 112 to be transferred to the first axle 102. The footrest 112 has a footrest hinge 301 that permits the footrest 112 to be folded to a position in a plane that is parallel to a plane of the first wheel 105. A hinging sequence is illustrated in phantom view. Alternatively, the footrest 112 may be configured as a removable element. The hinging and removable features of the footrest 112 aid in the compact storage of the vehicle as will be described herein. In the extended position, the footrest 112 also comprises a force transfer element 302 which functions to receive a force from the rider's placement of their foot or feet 202,203 on the footrest 112 and transfer the force to the fork stem 107 and the frame 101 through the first axle 102.

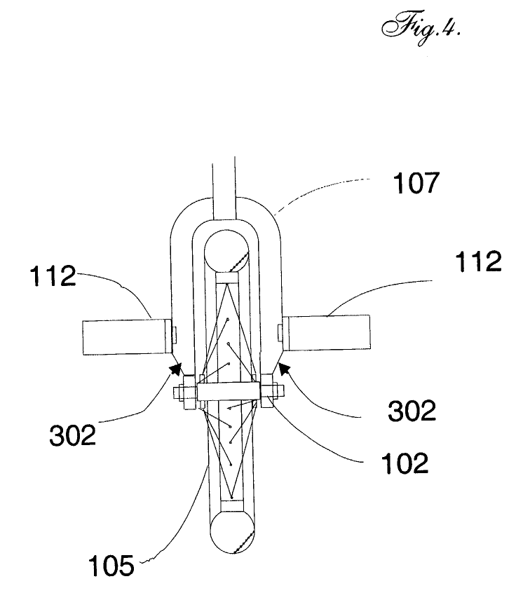

With specific reference to FIG. 4 of the drawings, there is shown an alternate embodiment of a footrest 112 and force transfer element 302 according to the teachings of the present invention in which the footrest 112 is not co-linear with the first axle 102, but extends perpendicular to the plane of the first wheel 105 from a position above the centerline of the first axle 102 and on the fork stem 107. In this embodiment, the footrest 112 may be integral with the fork stem 107 or it may be attached to the front fork 107 in a way to permit removal and reattachment. In this embodiment, the force transfer element 302 transfers the force of the rider's weight from the footrest 112 through the fork stem 107 to the first axle 102.

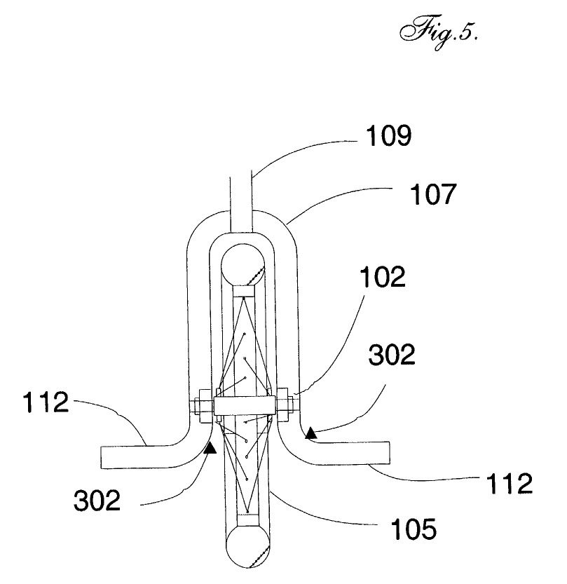

With specific reference to FIG. 5 of the drawings, there is shown another embodiment of the footrest 112 according to the teachings of the present invention in which the footrest 112 is an extension of the fork stem 107 below the centerline of the first axle 102. In this embodiment, the force transfer element 302 comprises a 90 degree curved tube connecting the first axle 102 to the footrest 112.

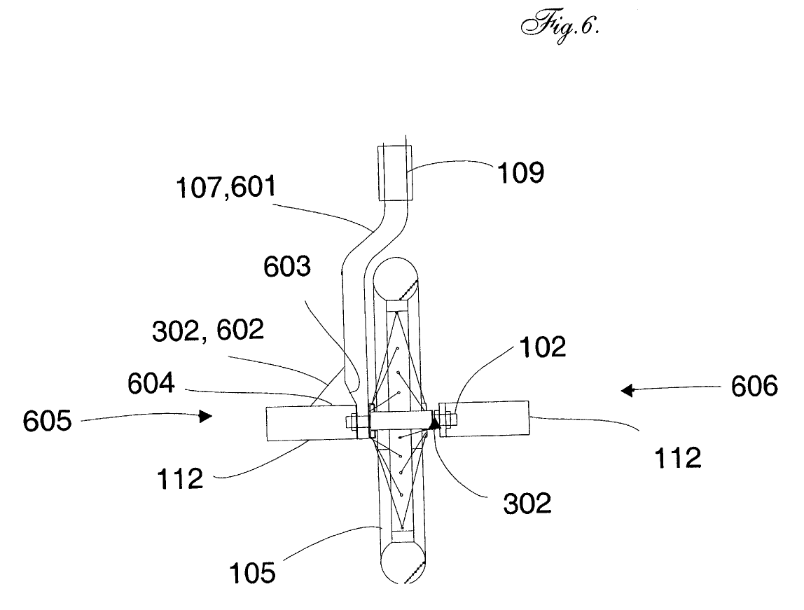

With specific reference to FIG. 6 of the drawings, there is shown another embodiment of the footrest according to the teachings of the present invention in which the fork stem 107 comprises a monofork 601. In the embodiment illustrated in FIG. 6, the footrest 112 is co-linear with the first axle 102, but due to the nature of a support structure associated with the monofork 601, each footrest 112 has a different embodiment of a force transfer element 302. On a first side of the vehicle 605, a triangular stiffening strut 602 attaches to a length of the monofork 602 along a first side of the strut 603 and the footrest 112 along a second side of the strut 604. On a second side of the vehicle 606 of the footrest 112, the force transfer element 302 is that shown in FIG. 3 and may be hinged or not.

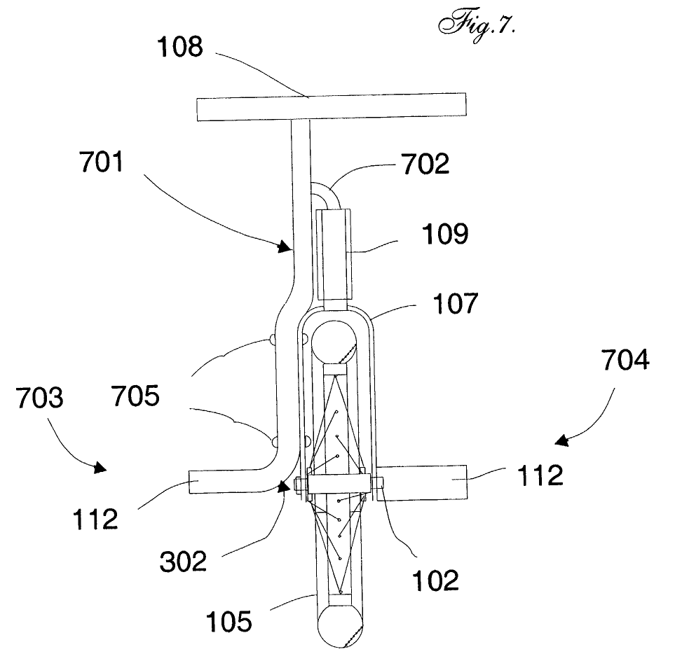

With specific reference to FIG. 7 of the drawings, there is shown another embodiment of a vehicle and footrest configuration according to the teachings of the present invention in which a footrest 112 stem connector 701 attaches to both the head tube 109 and the front fork 107. The footrest stem connector 701 transfers a portion of a force placed on the handlebars 108 via a head tube link 702 to the head tube 109 and front fork 107. In the embodiment shown, the first side of the vehicle 703 has a footrest 112 comprising an extension of the footrest stem connector 701 perpendicular to the plane of the first wheel 105. The force transfer element 302 comprises an elbow section integral with the footrest stem connector 701 that connects to the footrest 112. In the embodiment disclosed, the footrest 112 on the first side of the vehicle 703 is substantially co-linear with a centerline of the first axle 102, but is not attached thereto. Accordingly, a force placed on the footrest 112 on the first side of the vehicle 703 is transferred to the first axle 102 through the fork stem connector 701 and fork stem 107 and not directly to the first axle 102 through the footrest 112. For purposes of disassembly of the vehicle, quick release connectors 705 attach the footrest stem connector 701 to the front fork 107. On a second side of the vehicle 704, the footrest 112 is co-linear with the first axle 102 and is attached directly thereto as previously described with respect to FIG. 3 of the drawings.

As one of ordinary skill in the art can appreciate, the purpose of the embodiments shown in FIGS. 3-7 is illustrative and not exhaustive and shows a few of the various alternative embodiments for receiving a force placed on the footrest 112 by a rider 201 and efficiently distributing the force to the axles and tires of the personal transportation vehicle while providing an advantageous body placement for the rider 201 on a compact vehicle.

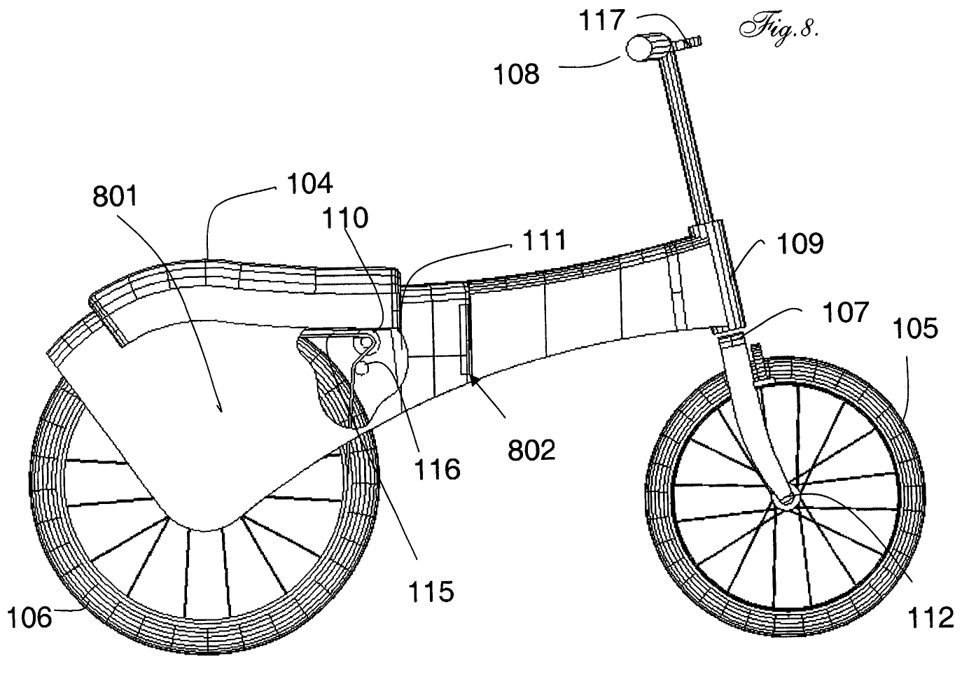

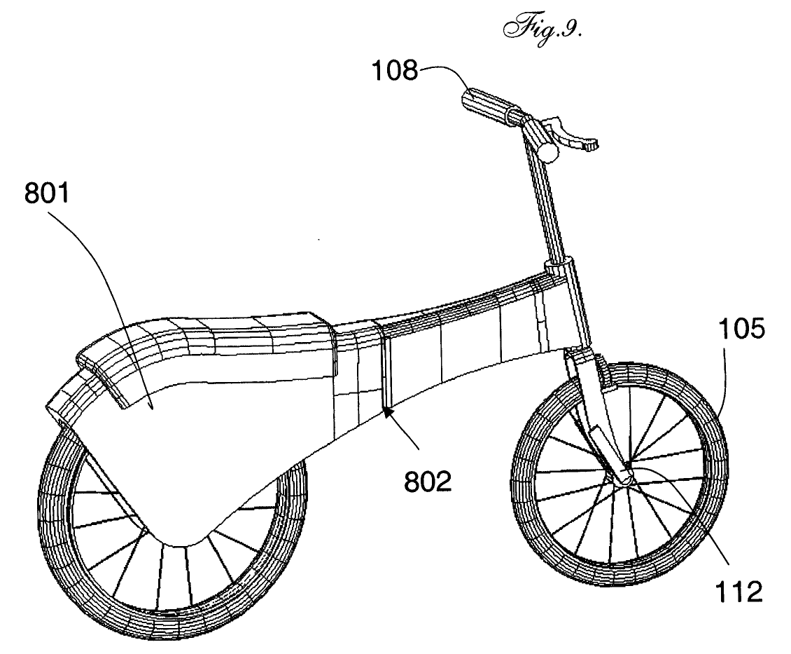

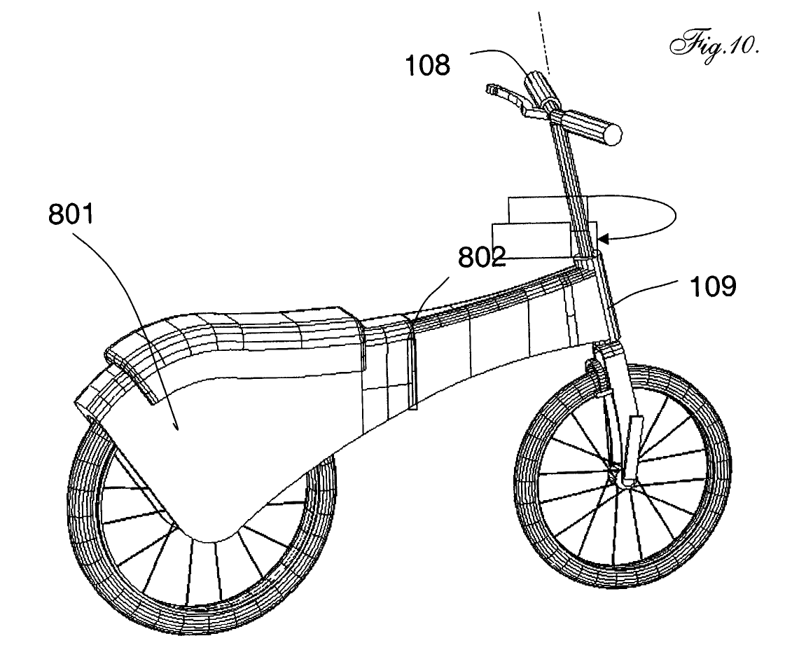

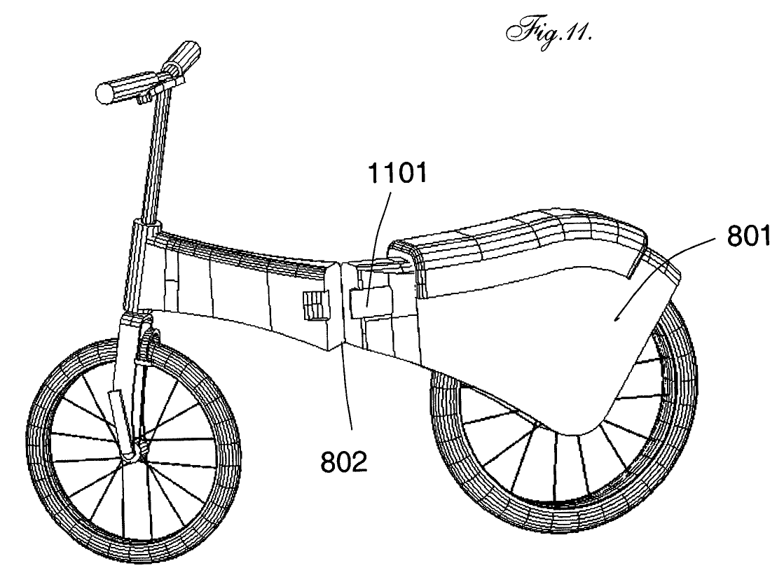

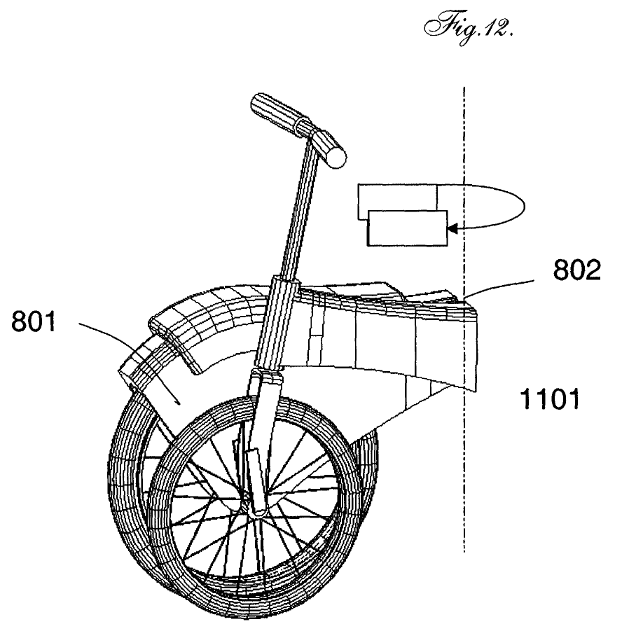

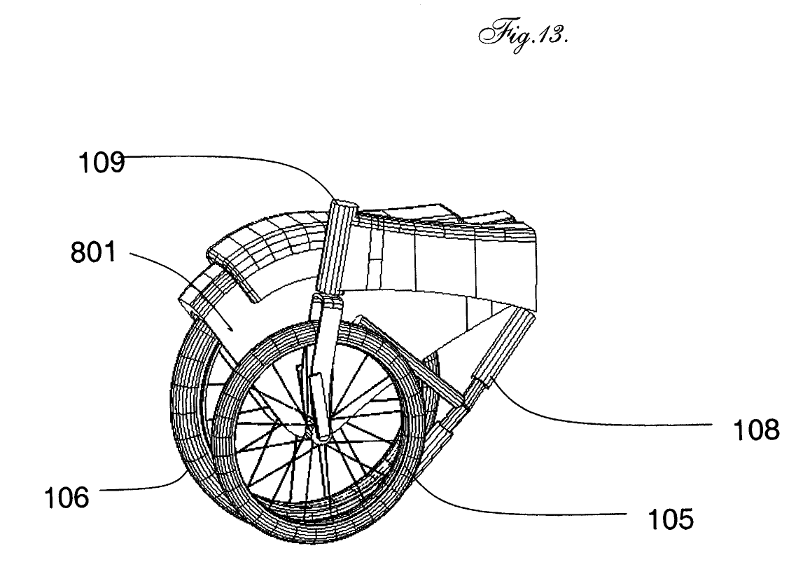

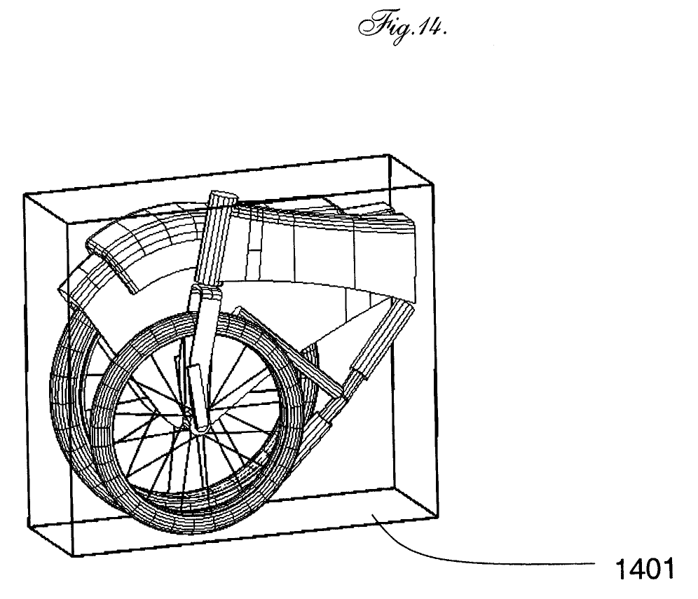

With specific reference to FIGS. 8-14 of the drawings, there is shown a fold sequence for an embodiment of a personal transportation vehicle according to the teachings of the present invention in which a streamlined frame 801 is illustrated. The frame 801 comprises a hollowed structure having two identical and integral halves connected along their lengths. In the streamlined frame, the frame may cover the motor 110, energy storage device 111, and pulleys (shown underneath the frame 801 in cutaway a view) thereby protecting the rider (not shown). The seat 104 may be configured as a cushioned portion of the frame 801 for rider comfort. In a foldable embodiment, the frame 801 is hinged at a frame hinge 802 at a position between the seat 104 and the head tube 109. With respect to FIG. 9 of the drawings, the initiation of the fold sequence is begun by folding (or removal) of the footrests 112. Next The first wheel 105 is also rotated 180 degrees as shown in FIG. 10. FIG. 11 shows the frame latch 1101 unhooked so that the frame may be folded around the frame hinge 802. The frame 801 is then folded to the storage position shown in FIG. 12. As shown in FIG. 13, the handlebars are removed and compactly placed between the first and second wheels 105, 106. Folded as described, the vehicle may be placed in a carrying case 1401 slightly larger than a typical briefcase for storage or further travel by the rider on foot or public transportation.

Although preferred embodiments of the invention are described, they are illustrative only and do not exhaustively describe all possible variants. Other embodiments and modifications of the invention are possible and are covered by the spirit and scope of the appended claims.

1. A personal transportation vehicle comprising;
a frame,
first and second wheels positioned on respective first and second axles mounted on said frame,
a motor driving at least one of said wheels,
a seat supported by said frame,
a footrest and,
a force transfer element receiving a force placed on said footrest and transferring said force to said first axle.

2. A personal transportation vehicle as recited in claim 1 and further comprising a pivotable fork stem with handlebars mounted thereon, said front wheel being responsive to movement of said handlebars via said pivotable fork stem.

3. A personal transportation vehicle as recited in claim 1, said footrest being connected to said first axle.

4. A personal transportation vehicle as recited in claim 3, wherein said force transfer element connects said footrest to said first axle.

5. A personal transportation vehicle as recited in claim 3, said force transfer element being unitary with said footrest.

6. A personal transportation vehicle as recited in claim 3, wherein said force transfer element is co-axial with said footrest.

7. A personal transportation vehicle as recited in claim 1 wherein said frame is collapsible.

8. A personal transportation vehicle as recited in claim 7 wherein footrest pivots to be substantially parallel with a plane of said first wheel.

9. A personal transportation vehicle as recited in claim 1 wherein said motor is an electric motor.

10. A personal transportation vehicle as recited in claim 9 wherein said motor comprises a high revolutions per minute direct current motor powered by an energy storage device.

11. A personal transportation vehicle as recited in claim 1 wherein said motor drives said second wheel.

12. A personal transportation vehicle comprising:
a frame,
first and second wheels positioned on respective first and second axles mounted on said frame,
a means for supporting a seat on said frame,
a means for propelling at least one of said wheels,
a means for providing a foot rest on said first axle, and
a means for receiving a force placed on said foot rest and transferring said force to said first axle.

13. A personal transportation vehicle as recited in claim 12 and further comprising handlebars and a means for moving said first wheel responsive to forces placed on said handlebars.

14. A personal transportation vehicle as recited in claim 12 wherein said means for receiving a force and said means for transferring a force are unitary with each other.

15. A personal transportation vehicle as recited in claim 12 wherein said means for receiving a force and said means for transferring a force are coaxial with each other.

16. A personal transportation vehicle as recited in claim 12 wherein said frame is collapsible.

17. A personal transportation vehicle as recited in claim 12 wherein said means for providing a foot rest pivots to be substantially parallel with a plane of said wheel.

18. A personal transportation vehicle as recited in claim 12 wherein said means for propelling comprises an electric motor.

19. A personal transportation vehicle as recited in claim 12 wherein said means for propelling comprises a high revolutions per minute direct current motor powered by an energy storage device.

20. A personal transportation vehicle as recited in claim 12 wherein said means for propelling, propels said second wheel.

21. A personal transportation vehicle as recited in claim 12 wherein said seat is positioned sufficiently close to a surface on which the personal transportation device is in use such that a rider of the personal transportation vehicle may assist in propelling the personal transportation vehicle.

22. A personal transportation vehicle as recited in claim 21 wherein said footrest is sufficiently forward of said seat such that said rider is unhindered by said footrest during said assisted propelling.

23. A personal transportation vehicle comprising:
a bicycle frame having a seat and handlebars,
first and second wheels mounted to said bicycle frame on respective first and second axles,
a motor propelling at least one of said wheels, and
a footrest and,
a force transfer element for receiving a force placed on said footrest and transferring said force to said first axle.

24. A personal transportation vehicle as recited in claim 23, said footrest being connected to said first axle.

25. A personal transportation vehicle as recited in claim 24, said force transfer element being unitary with said footrest.

26. A personal transportation vehicle as recited in claim 24, wherein said force transfer element is co-axial with said footrest.

27. A personal transportation vehicle as recited in claim 23 wherein said frame is collapsible.

28. A personal transportation vehicle as recited in claim 27 wherein footrest pivots to be substantially parallel with a plane of said first wheel.

29. A personal transportation vehicle as recited in claim 23 wherein said motor is an electric motor.

30. A personal transportation vehicle as recited in claim 23 wherein said motor comprises a high revolutions per minute direct current motor powered by an energy storage device.

31. A personal transportation vehicle as recited in claim 23 wherein said motor drives said second wheel.
